(19) United States
(12) Patent Application Publication
(10) Pub. No.: US 2022/0103705 A1
(43) Pub. Date: Mar. 31, 2022

(54) IMAGE FORMING APPARATUS AND DISPLAY CONTROL METHOD FOR OPERATION GUIDE

(71) Applicant: SHARP KABUSHIKI KAISHA, Osaka (JP)

(72) Inventor: MIYOKO MARUYAMA, Osaka (JP)

(21) Appl. No.: 17/401,797

(22) Filed: Aug. 13, 2021

(30) Foreign Application Priority Data
Sep. 28, 2020 (JP) 2020-162267

(51) Int. Cl. H04N 1/00

(52) U.S. Cl. CPC H04N 1/00408; H04N 2201/0094; H04N 1/00503; H04N 1/00477

(57) ABSTRACT

An image forming apparatus includes: an operation recognizer that receives, from a user, an operation for a setting and an instruction regarding image formation; a job controller that performs control on the setting and the instruction in response to the operation received by the operation recognizer; an image former that executes image formation in accordance with the setting and the instruction under control of the job controller; and a display controller that displays, to the user, a status regarding the setting and the instruction under control of the job controller, wherein the job controller causes the display controller to display an operation guide for an explanation of the operation in response to a request by the user, and determines an operation guide to be displayed based on at least either a setting when the request is received or a status when the request is received.

### BACKGROUND OF THE INVENTION

### Field of the Invention

The present invention relates to an image forming apparatus capable of displaying an operation guide and a display control method for an operation guide for image formation.

### Description of the Background Art

An image forming apparatus, especially a multifunction peripheral capable of executing a plurality of functions for image formation, has many functions to be selected or set by a user, and the operations performed by the user to obtain the desired output tend to be complicated. Therefore, the often-used configuration uses a dot-matrix display, which allows a flexible change in the display content of an operation screen depending on the situation, and correspondingly uses a touch panel, which receives a user instruction, as an operation recognizer. Nevertheless, it is not easy to display many functions on a display device and guide operations in a user-friendly manner.

Operation manuals are provided in booklets and text data (e.g., PDF format data) as documents for helping users understand many functions. However, the operation manuals are far from being fully used by users as the users do not keep the operation manual at hand when needed or the users have difficulty in finding the necessary information from many items.

According to a disclosed technique, an operation key is previously stored in association with an item of an electronic operation manual, an item of the operation manual associated with an input operation key is read, and the item is displayed on a display device (see, for example, Japanese Unexamined Patent Application Publication No. 2010-185994).

Furthermore, according to a disclosed technique, an electronic manual (standard manual) about, for example, how to operate a standard user interface screen (UI screen) displayed on a display device of an image forming apparatus is automatically changed in accordance with the customization of the UI screen (see, for example, Japanese Unexamined Patent Application Publication No. 2009-31942). When the presence or absence and the location of UI components (e.g., operation keys or sliders) on the standard UI screen are changed, a customized manual is generated in which the presence or absence and the order of texts for an operation of the standard manual have been accordingly changed.

An explanation for an operation displayed on a display device, or the like, of an image forming apparatus as in Japanese Unexamined Patent Application Publication No. 2010-185994 and Japanese Unexamined Patent Application Publication No. 2009-31942 is referred to as “operation guide” in this description.

Unlike a printed operation manual, the user may always keep the operation guide at hand so as to refer to the operation guide when operating the image forming apparatus. Due to limitations such as the size of a display screen or the memory capacity, the amount of information provided by the conventional operation guides is limited as compared to printed operation manuals, and therefore the conventional operation guides often have difficulty in aiding in solving user's problems. That is, there is lack of actual usability. With the progress of display devices and memory devices, however, it has recently become possible to achieve almost the same or the same amount of information as compared to printed materials.

The present invention has been made in consideration of the above circumstances to provide an operation guide that has almost the same or preferably the same amount of information as compared to printed operation manuals and that may provide more convenience than printed operation manuals.

### SUMMARY OF THE INVENTION

In order to solve the above-described disadvantage, the present invention provides an image forming apparatus including: an operation recognizer that receives, from a user, an operation for a setting and an instruction regarding image formation; a job controller that performs control on the setting and the instruction in response to the operation received by the operation recognizer; an image former that executes image formation in accordance with the setting and the instruction under control of the job controller; and a display controller that displays, to the user, a status regarding the setting and the instruction under control of the job controller, wherein the job controller causes the display controller to display an operation guide for an explanation of the operation in response to a request by the user, and determines an operation guide to be displayed based on at least either a setting when the request is received or a status when the request is received.

Furthermore, according to another aspect, the present invention provides a display control method for an operation guide causing a computer to execute: receiving, by an operation recognizer from a user, an operation for a setting and an instruction regarding image formation; performing control on the setting and the instruction in response to the operation received by the operation recognizer; executing image formation in accordance with the setting and the instruction; displaying, by a display controller, a status regarding the setting and the instruction to a user; and displaying, by the display controller, an operation guide for an explanation of the operation in response to a request by the user, wherein the displaying, by a job controller, determines an operation guide to be displayed based on at least either a setting when the request is received or a status when the request is received.

The image forming apparatus according to the present invention includes the job controller that performs control on the setting and the instruction in response to the operation received by the operation recognizer, and the job controller causes the display controller to display an operation guide for the setting and the instruction in response to a request by the user and determines an operation guide to be displayed based on at least either a setting when the request is received or a status when the request is received, whereby it is possible to provide more convenience than printed operation manuals.

The display control method for the operation guide according to the present invention also has the same advantageous effect.

### BRIEF DESCRIPTION OF THE DRAWINGS

FIG. 1 is a block diagram illustrating a configuration of a multifunction peripheral as an image forming apparatus according to the present embodiment.

FIG. 2 is a perspective view illustrating an external appearance of the multifunction peripheral illustrated in FIG. 1.

FIG. 3A is an explanatory diagram illustrating that a display unit of the multifunction peripheral displays a home screen and a user performs an operation to make a request for displaying an operation guide according to an embodiment.

FIG. 3B is an explanatory diagram illustrating a situation where a table of contents of the overall operation guide is displayed in response to the request for displaying the operation guide illustrated in FIG. 3A and the user selects an item “before using the machine”.

FIG. 3C is an explanatory diagram illustrating an example of the operation guide displayed by a job controller in response to the selection of the item “before using the machine” illustrated in FIG. 3B.

FIG. 3D is an explanatory diagram illustrating a part of a printed operation manual corresponding to the operation guide illustrated in FIG. 3C.

FIG. 4A is an explanatory diagram illustrating that the display unit of the multifunction peripheral displays the home screen and the user performs an operation to select an “easy copy” job according to an embodiment.

FIG. 4B is an explanatory diagram illustrating that a copy operation screen in an easy mode is displayed in response to the selection of “easy copy” illustrated in FIG. 4A and the user performs an operation to make a request for displaying the operation guide.

FIG. 4C is an explanatory diagram illustrating an operation guide for a table of contents regarding a copy job, which is displayed by the job controller in response to the request for displaying the operation guide illustrated in FIG. 4B.

FIG. 4D is an explanatory diagram illustrating a part of the printed operation manual corresponding to the table of contents for the copy job illustrated in FIG. 4C.

FIG. 5A is an explanatory diagram illustrating that the display unit of the multifunction peripheral displays the home screen and the user performs an operation to select an “easy copy” job according to an embodiment.

FIG. 5B is an explanatory diagram illustrating that the copy operation screen in the easy mode is displayed in response to the selection of “easy copy” illustrated in FIG. 5A and the user performs an operation to switch to an operation screen in a normal mode.

FIG. 5C is an explanatory diagram illustrating that the copy operation screen in the normal mode is displayed in response to the operation of switching to the operation screen in the normal mode illustrated in FIG. 5B and the user performs an operation to select “other functions”.

FIG. 5D is an explanatory diagram illustrating that, in response to the selection of “other functions” illustrated in FIG. 5C, an operation window for “other functions” is displayed and the user performs an operation to select “punch”.

FIG. 5E is an explanatory diagram illustrating that, in response to the selection of “punch” illustrated in FIG. 5D, an operation window for “punch” is displayed and the user performs an operation to make a request for displaying an operation guide.

FIG. 5F is an explanatory diagram illustrating an operation guide for a “punch” function displayed by the job controller in response to the request for displaying the operation guide illustrated in FIG. 5E.

FIG. 6A is an explanatory diagram illustrating a situation in which, in the operation window for “punch” corresponding to FIG. 5E, the user performs an operation to set “left” as the punch position and an unacceptable setting message is displayed.

FIG. 6B is an explanatory diagram illustrating that the user performs an operation to make a request for displaying an operation guide while the message illustrated in FIG. 6A is displayed.

FIG. 6C is an explanatory diagram illustrating an operation guide for an unacceptable setting message displayed by the job controller in response to the request for displaying the operation guide illustrated in FIG. 6B.

FIG. 7A is an explanatory diagram illustrating that, when the function of “send as well as print” is prohibited by the system setting, the copy operation screen in the normal mode corresponding to FIG. 5C is displayed and the operation is performed to make a request for displaying the operation guide.

FIG. 7B is an explanatory diagram (corresponding to FIG. 40) illustrating an operation guide of a table of contents for a copy job displayed by the job controller in response to the request for displaying the operation guide illustrated in FIG. 7A.

FIG. 8A is an explanatory diagram illustrating that the copy operation screen in the easy mode is displayed and the user performs an operation to select “N-up”.

FIG. 8B is an explanatory diagram illustrating that the user performs an operation to select “copy ratio” after the function of N-up has been set by the operation in FIG. 8A.

FIG. 8C is an explanatory diagram illustrating that, while an operation screen of “copy ratio” is displayed by the operation in FIG. 8B, the user selects “automatic ratio selection” and accordingly a copy ratio of 65% is set.

FIG. 8D is an explanatory diagram illustrating that the user performs an operation to make a request for displaying an operation guide on the operation screen of “copy ratio” illustrated in FIG. 8C.

FIG. 8E is an explanatory diagram illustrating an operation guide for items regarding copy ratio setting displayed by the job controller in response to the request for displaying the operation guide illustrated in FIG. 8D.

FIG. 9A is an explanatory diagram illustrating that the copy operation screen in the normal mode is displayed in a multifunction peripheral attached to a saddle finisher having staple and punch functions and a paper folding unit and the user performs an operation to select “finish” according to an embodiment.

FIG. 9B is an explanatory diagram illustrating that, in response to the selection of “finish” illustrated in FIG. 9A, a “fold” tab is displayed in an operation window of “finish” and the user performs an operation to make a request for displaying an operation guide.

FIG. 9C is an explanatory diagram illustrating an operation guide for the settings of a “fold” function displayed by the job controller in response to the request for displaying the operation guide illustrated in FIG. 9B.

FIG. 9D is an explanatory diagram (corresponding to FIG. 9B) illustrating, in response to the selection of “finish” in the multifunction peripheral to which a saddle finisher having staple and punch functions is attached and a paper folding unit is not attached, the “fold” tab is displayed on the “finish” operation window and the user performs an operation to make a request for displaying an operation guide according to an embodiment.

FIG. 9E is an explanatory diagram (corresponding to FIG. 9C) illustrating an operation guide for the setting of the “fold” function displayed by the job controller in response to the request for displaying the operation guide illustrated in FIG. 9D.

FIG. 10A is an explanatory diagram illustrating that, when the system settings permit the execution of both black-and-white copying and color copying, the copy operation screen in the easy mode is displayed as in FIG. 4B and the user performs an operation to make a request for displaying an operation guide.

FIG. 10B is an explanatory diagram illustrating a display example of a part of an operation guide for a copy job, which is displayed by the job controller in response to the request for displaying the operation guide illustrated in FIG. 10A, including the illustration of the operation screen.

FIG. 10C is an explanatory diagram illustrating that, when the execution of color copying is prohibited by the system setting, the copy operation screen in the easy mode corresponding to FIG. 10A is displayed and the user performs an operation to make a request for displaying an operation guide.

FIG. 10D is an explanatory diagram illustrating an example in which the job controller displays the part of the operation guide corresponding to FIG. 10B in response to the request for displaying the operation guide illustrated in FIG. 10C.

FIG. 11A is an explanatory diagram illustrating that, when the system setting prohibits the display of a sending history, a fax operation screen in the easy mode is displayed and the user performs an operation to make a request for displaying an operation guide.

FIG. 11B is an explanatory diagram illustrating a display example of a part of an operation guide for a fax job, which is displayed by the job controller in response to the request for displaying the operation guide illustrated in FIG. 11A, including the illustration of the operation screen.

FIG. 12A is a first flowchart illustrating an example of a process for displaying an operation guide among the processes executed by the job controller according to an embodiment.

FIG. 12B is a second flowchart illustrating an example of a process for displaying an operation guide among the processes executed by the job controller according to an embodiment.

### DESCRIPTION OF THE PREFERRED EMBODIMENTS

The present invention will be further described in detail below with reference to the drawings. The description below is an example in all respects and should not be considered to limit the present invention.

Configuration of Image Forming Apparatus

First, an image forming apparatus according to the present embodiment is described.

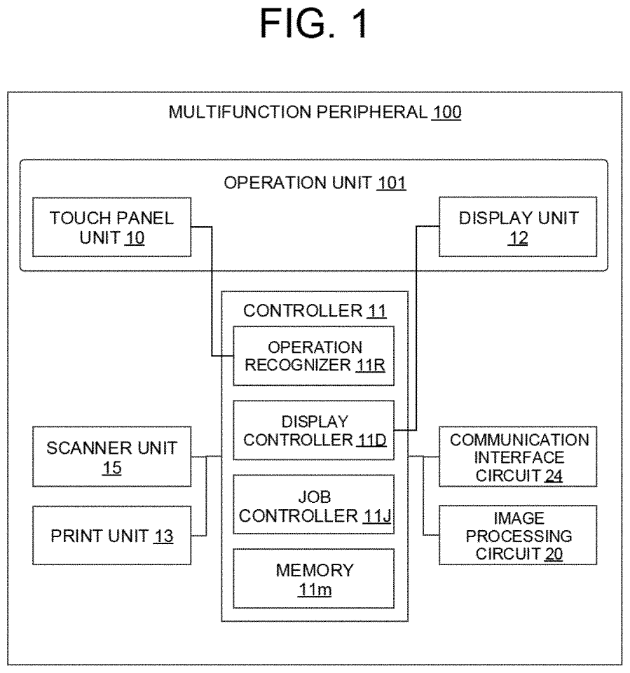

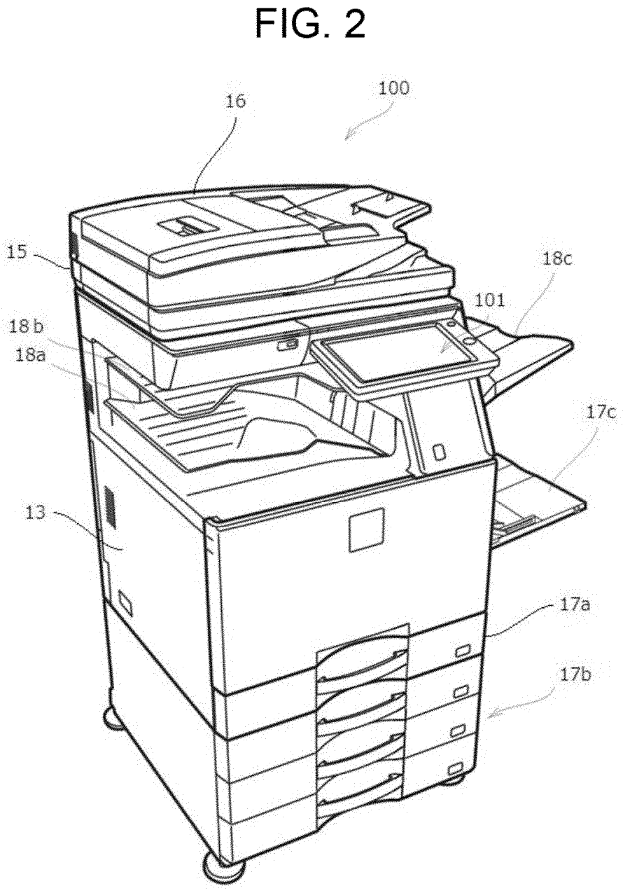

FIG. 1 is a block diagram illustrating a configuration of a multifunction peripheral as one form of the image forming apparatus according to the present embodiment. FIG. 2 is a perspective view illustrating an external appearance of the multifunction peripheral illustrated in FIG. 1.

As illustrated in FIG. 1, a multifunction peripheral 100 includes an operation unit 101, a controller 11, a print unit 13, a scanner unit 15, a communication interface circuit 24, and an image processing circuit 20. The operation unit 101 includes a touch panel unit 10 and a display unit 12. The controller 11 includes an operation recognizer 11R, a display controller 11D, a job controller 11J, and a memory 11m.

As illustrated in FIG. 2, the operation unit 101 is provided in a chassis of the multifunction peripheral 100 and includes the display unit 12 and the touch panel unit 10 that receives user operations on a display screen of the display unit 12 as illustrated in FIG. 1.

The operation recognizer 11R recognizes the signal of an operation detected by the touch panel unit 10 and recognizes which element on the display screen of the display unit 12 have been operated.

The display unit 12 includes, for example, a liquid crystal display device. The display unit 12 displays a screen under the control of the display controller 11D. The job controller 11J determines the content to be displayed on the display unit 12 by the display controller 11D based on the operation recognized by the operation recognizer 11R or the status of the multifunction peripheral 100 and updates the content.

The job controller 11J recognizes the status detected by sensors (not illustrated) provided in the scanner unit 15 and the print unit 13. The job controller 11J controls operations of motors, actuators, devices, etc. (not illustrated) provided in the scanner unit 15 and the print unit 13. Further, the job controller 11J controls image processing by the image processing circuit 20.

The controller 11 including the operation recognizer 11R, the display controller 11D, and the job controller 11J primarily includes, for example, a central processing unit (CPU) or a micro processing unit (MPU) (hereinafter in this description, the CPU and the MPU are collectively referred to as “CPU” or “computer”) as a specific configuration mode. In addition, the controller 11 includes hardware resources such as a memory, an input/output interface circuit, or a timer circuit. The CPU described above executes a control program stored in the memory 11m so as to perform various jobs for the recognition of an operation, the control on display, the reading of an original image, the printing of an image, and the like, in other words, a series of processes for image formation.

The memory 11m includes, for example, a RAM and a non-volatile memory as a specific configuration mode. Examples of the hardware included in the non-volatile memory include a flash memory. The CPU described above reads a control program stored in the non-volatile memory and loads the control program to the RAM as appropriate. Then, the CPU performs processing in accordance with the control program loaded into the RAM so as to control the multifunction peripheral 100. That is, a function of the controller 11 is implemented by the cooperation of the software resources and the hardware resources.

The controller 11 is coupled to the print unit 13 and the scanner unit 15 so as to transfer data with each other.

The communication interface circuit 24 is an interface to perform data communications with an external device via a network.

As illustrated in FIG. 2, the multifunction peripheral 100 includes a document feed unit 16. Although not illustrated in FIG. 2, a document glass is included, which is hidden by the document feed unit 16.

The scanner unit 15 reads the image of an original and converts the image into an image signal under the control of the job controller 11J. That is, the scanner unit 15 performs the image reading processing for copy, fax, and scanner jobs.

The image processing circuit 20 generates image data based on the image signal output from the scanner unit 15. Alternatively, the image processing circuit 20 generates the image data for printing based on the print data received via the communication interface circuit 24. The generated image data is then printed by the print unit 13 or transmitted to an external device via the communication interface circuit 24.

As illustrated in FIG. 2, the multifunction peripheral 100 includes paper trays 17a, 17b, and 17c and output trays 18a, 18b, and 18c. The paper trays 17a and 17b individually accommodate sheets of various sizes. The paper tray 17c is a bypass tray having the exposed part where paper is placed so that the user may easily replace the paper.

A paper feed mechanism (not illustrated in FIGS. 1 and 2) feeds a sheet set in the selected paper tray 17a, 17b or 17c to the print unit 13 under the control of the job controller 11J.

The print unit 13 prints the designated image data on the sheet fed from the paper tray 17a, 17b or 17c under the control of the job controller 11J. Examples of jobs for printing include print jobs as printers, copy jobs as copiers, or facsimile reception jobs for fax reception.

A paper output mechanism (not illustrated in FIGS. 1 and 2) outputs the sheet having undergone printing by the print unit 13 to any selected one of the output trays 18a, 18b, and 18c under the control of the job controller 11J.

Control on Display for Operation Guide

According to the present embodiment, the job controller 11J controls the display controller 11D in response to a request by the user so as to display an operation guide on the display unit 12.

### First Embodiment

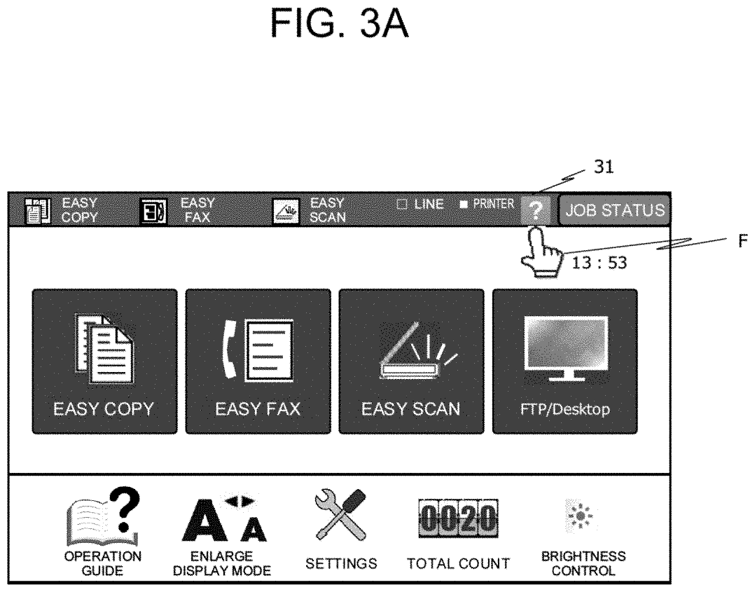

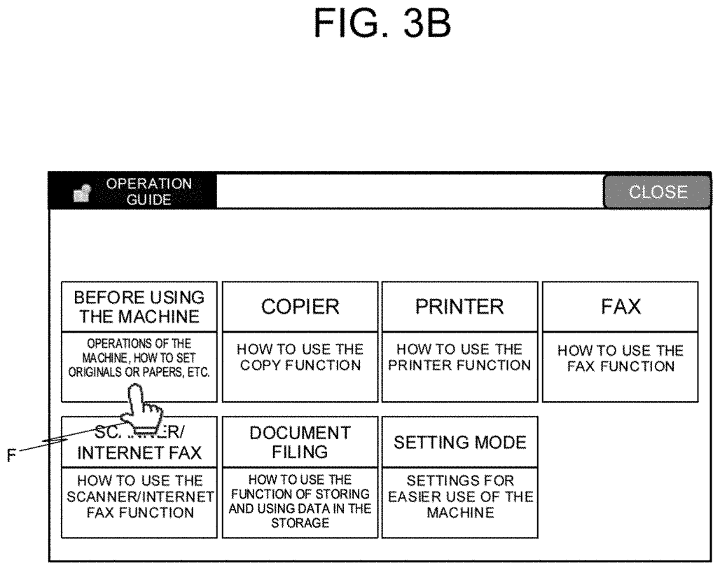

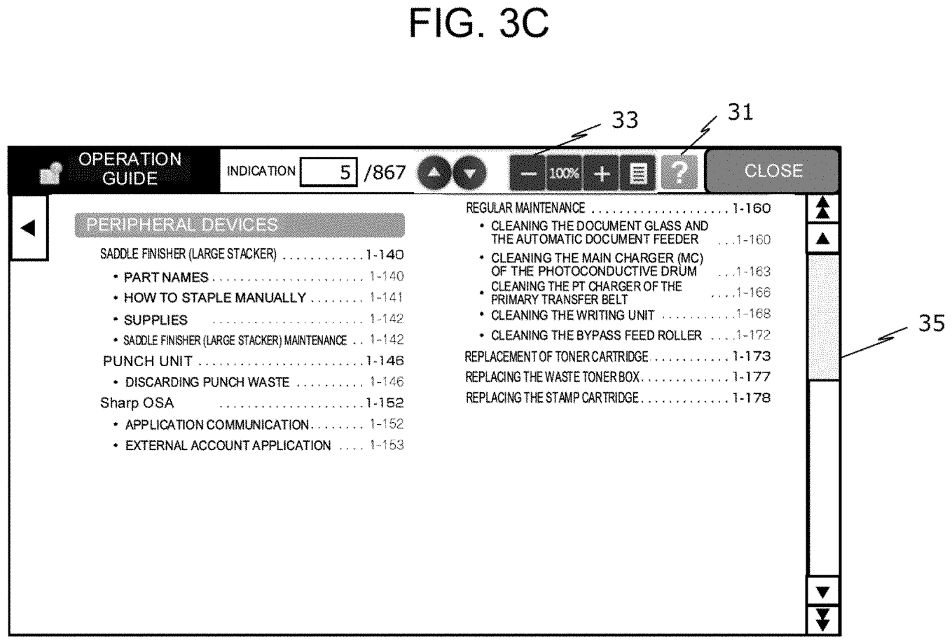

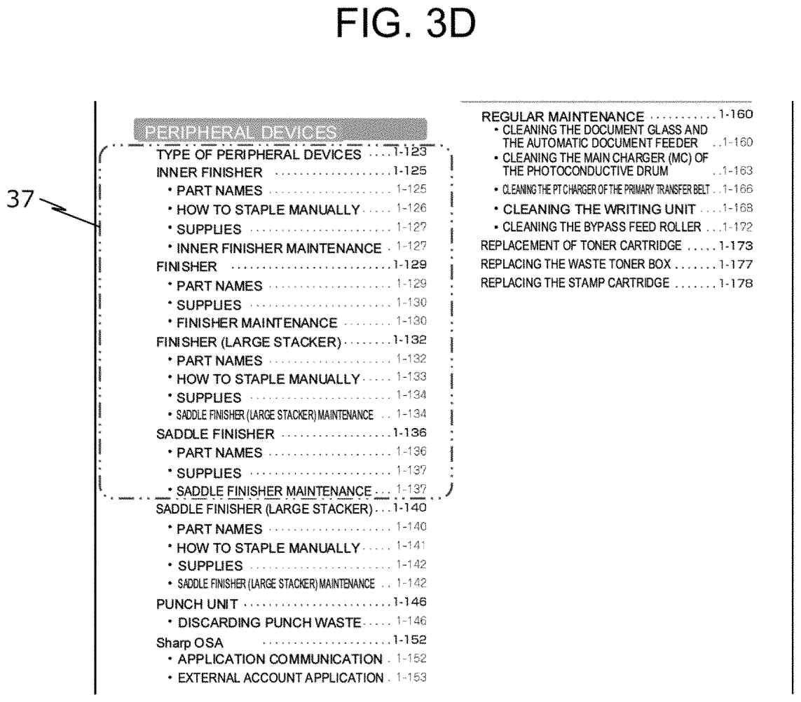

FIGS. 3A to 3C illustrate an example of the case where a request for displaying the operation guide is made on a home screen displayed on the display unit 12 by the display controller 11D. The home screen is a screen on which the operation is started when the user makes a setting and an instruction for image formation by the multifunction peripheral 100. That is, the home screen is a screen where the reset operation screen is displayed. It can also be said that the home screen is a screen located at the top of an operation screen tree.

Although the home screen includes operation keys for specifying various settings, the description for the individual operation keys is omitted. Here, a description is given of an operation guide key 31 that is operated by the user's touch with a finger F as illustrated in FIG. 3A.

When the touch panel unit 10 detects a touch on the display screen while the home screen is displayed, the operation recognizer 11R accordingly determines which display element on the home screen has been touched. Here, it is determined that the operation guide key 31 has been touched, and the operation is communicated to the job controller 11J.

In response to the touch on the operation guide key 31 of the home screen, the job controller 11J controls the display controller 11D so as to display a table of contents (see FIG. 3B) of the overall operation guide on the operation screen. The job controller 11J manages internal variables for the settings and execution of jobs. The job controller 11J manages the type and content of the operation screen displayed on the display unit 12 in response to the received operation. Thus, the job controller 11J determines that the home screen has been displayed when the operation guide key 31 is touched. The memory 11m previously stores the displayed operation screen and the part of the operation guide to be displayed when the operation guide key 31 is operated on the operation screen in such a manner that they are associated with each other, and therefore the job controller 11J may display the operation guide corresponding to the operation screen being displayed.

The table of contents for the overall operation guide illustrated in FIG. 3B includes the display of a plurality of categories arranged side by side. FIG. 3B illustrates the user operation of touching and selecting, with the finger F, an item “before using the machine” among the categories included in the table of contents of the overall operation guide.

When the touch panel unit 10 detects a touch on the display screen while the table of contents of the overall operation guide is displayed, the operation recognizer 11R accordingly determines which display element in the table of contents has been touched. Here, it is determined that the item “before using the machine” has been touched, and the operation is communicated to the job controller 11J.

In response to the touch on the item “before using the machine” on the screen for the table of contents of the overall operation guide, the job controller 11J controls the display controller 11D so as to display the corresponding item on the operation screen.

FIG. 3C illustrates the state where the table of contents for peripheral devices is displayed as an operation guide among the corresponding items. When any item in the displayed table of contents is touched, the job controller 11J displays the explanation part corresponding to the touched item as an operation guide.

As illustrated in FIG. 3C, the display screen for the operation guide displays an operation guide toolbar 33 at the upper end portion thereof and a scroll bar 35 at the right end portion thereof. The operation guide toolbar 33 includes the indication indicating the page of the printed operation manual corresponding to the displayed operation guide, the operation keys for the subsequent page and the previous page, the operation keys for display at a reduced size, the same size, and an enlarged size and the printing of the displayed page, the operation guide key 31, and the operation key for closing the operation guide. When the operation guide key 31 is operated on this page, the job controller 11J displays the explanations of the operation guide toolbar 33 and the scroll bar 35 as an operation guide. The scroll bar 35 includes display elements corresponding to the operations for movement within a page, the subsequent page/the previous page, and the subsequent item/the previous item.

FIG. 3D illustrates the part of the printed operation manual corresponding to the operation guide illustrated in FIG. 3C. Based on a comparison between FIG. 3C and FIG. 3D, the part surrounded by the double-dotted line in FIG. 3D is not displayed as the operation guide. The types of optional devices (peripheral devices) attachable to the multifunction peripheral 100 include an inner finisher, a finisher, a finisher (large stacker), a saddle finisher, and a saddle finisher (large stacker). Any one of them is attachable at once and, according to the present embodiment, it is assumed that the saddle finisher (large stacker) is attached to the multifunction peripheral 100. Based on the status of the multifunction peripheral 100, i.e., the configuration of the optional device, the job controller 11J displays the operation guide from which the part not included in the current configuration has been omitted. The items surrounded by the double-dotted line in FIG. 3D is a hidden part 37. As displaying the items not included in the current configuration on the operation guide is meaningless and may confuse the user, the items are omitted.

The job controller 11J manages internal variables for the settings and execution of jobs. The job controller 11J manages the type and content of the operation screen displayed on the display unit 12 in response to the received operation. Therefore, the job controller 11J may determine that the part displayed in the operation guide when the operation guide key 31 is touched includes an item that is not included in the current configuration indicated by the internal variable and may omit display of the item.

As it is determined whether each item is to be omitted, the display data for the operation guide is configured for each item, and the job controller 11J manages display of the operation guide for each item. This is different from the print data on the operation manual that is separated for each page.

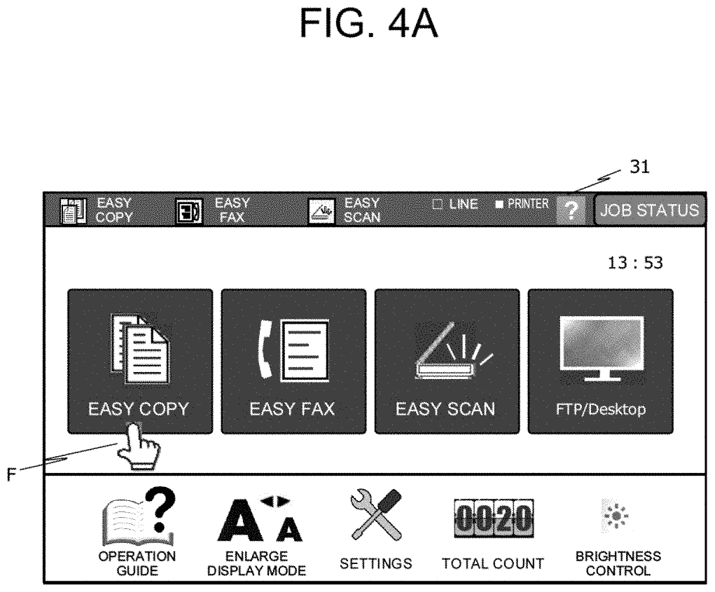

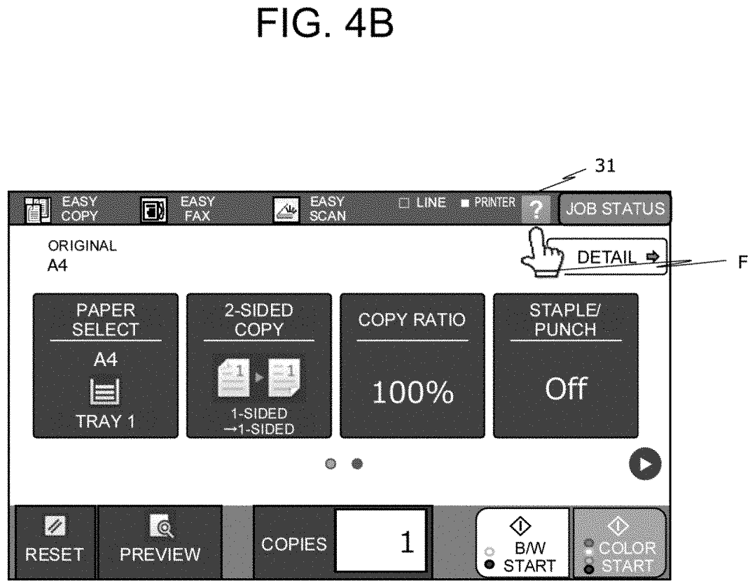

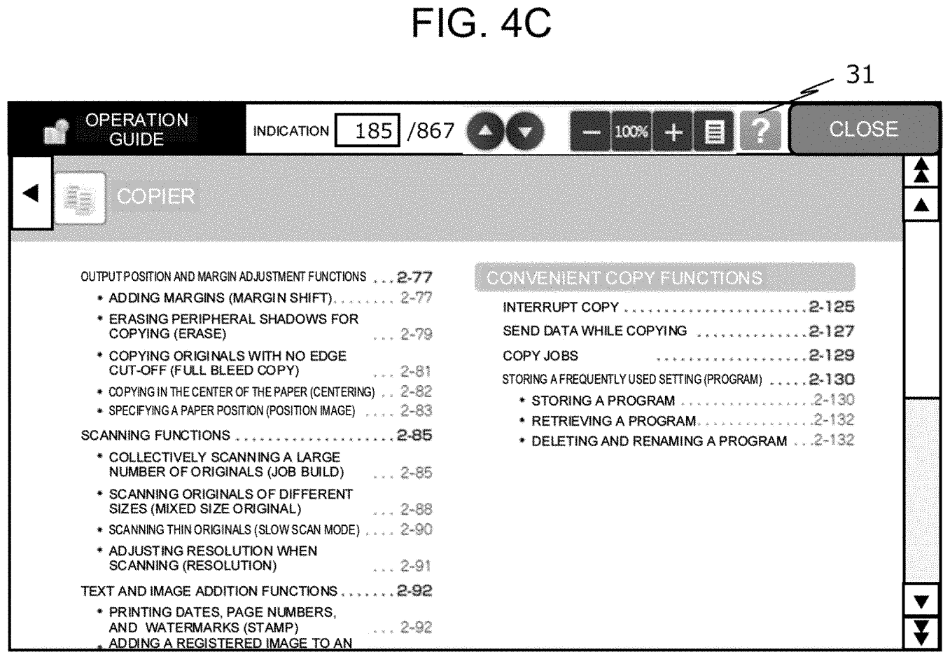

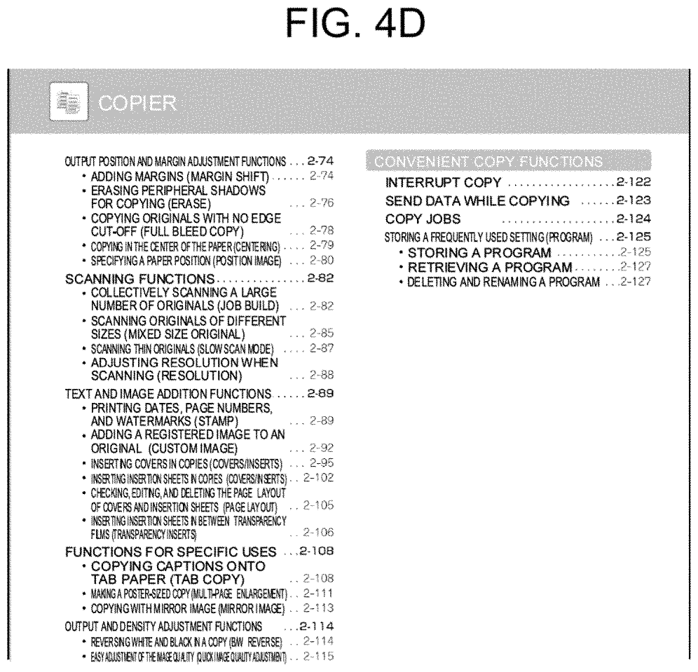

As described above with reference to FIGS. 3A and 3B, when the operation guide key 31 is operated on the home screen, the job controller 11J displays the table of contents of the overall operation guide. FIGS. 4A to 4D illustrate an example of the case where the operation guide key 31 is operated on the operation screen for each low-level job on the home screen.

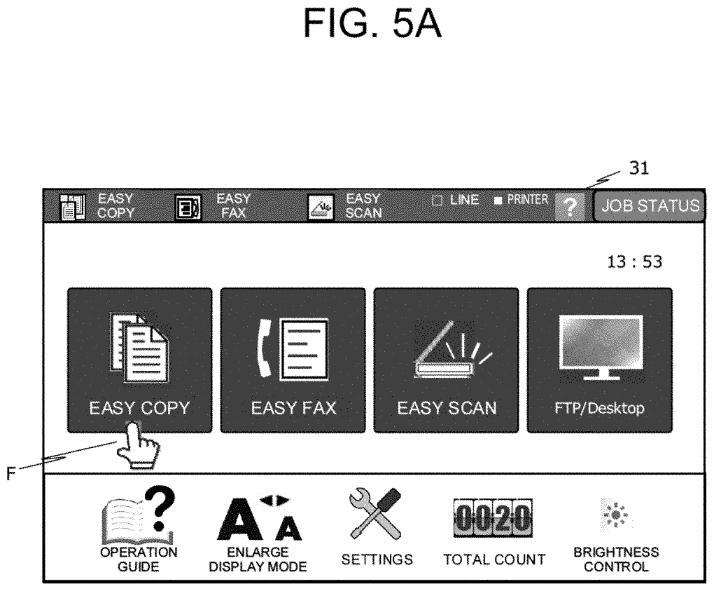

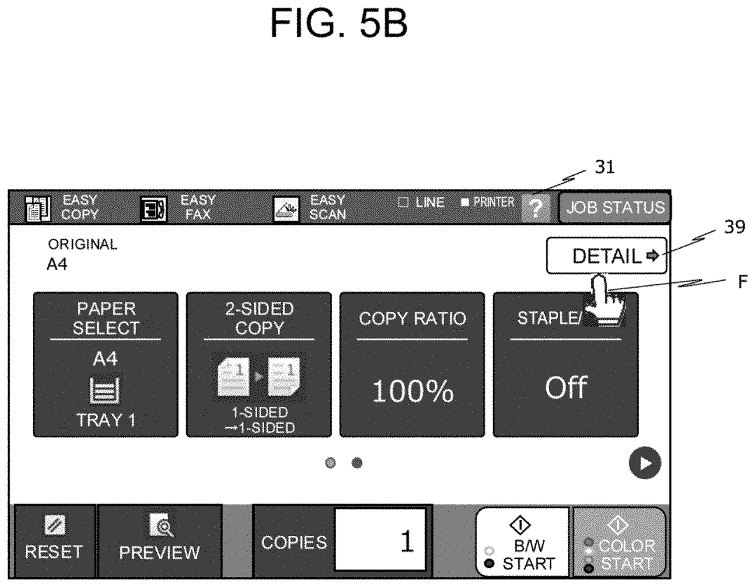

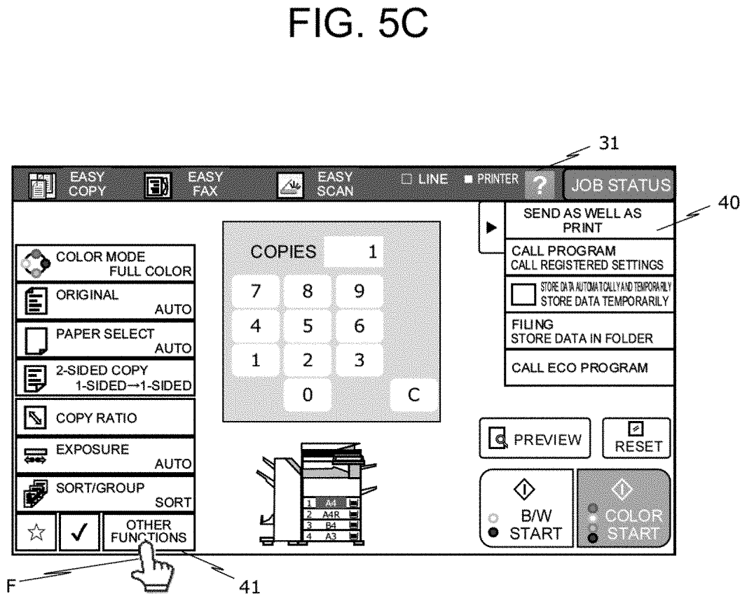

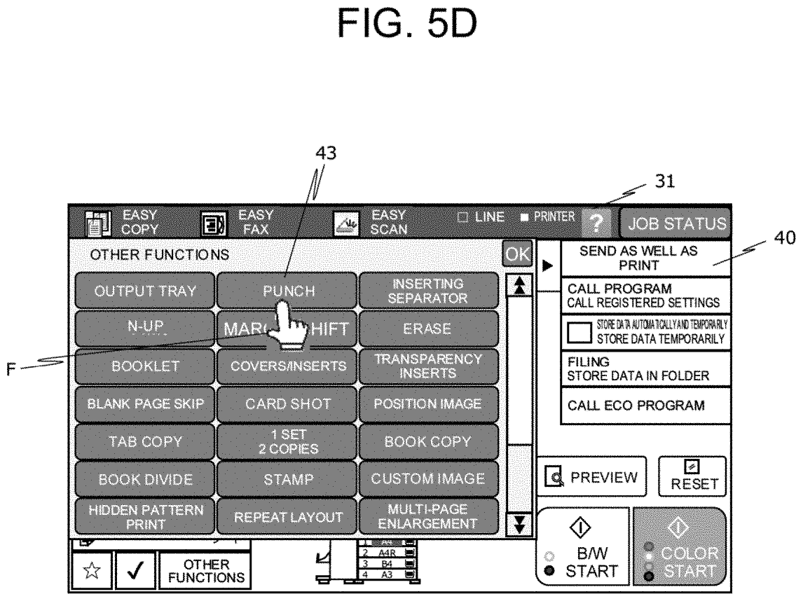

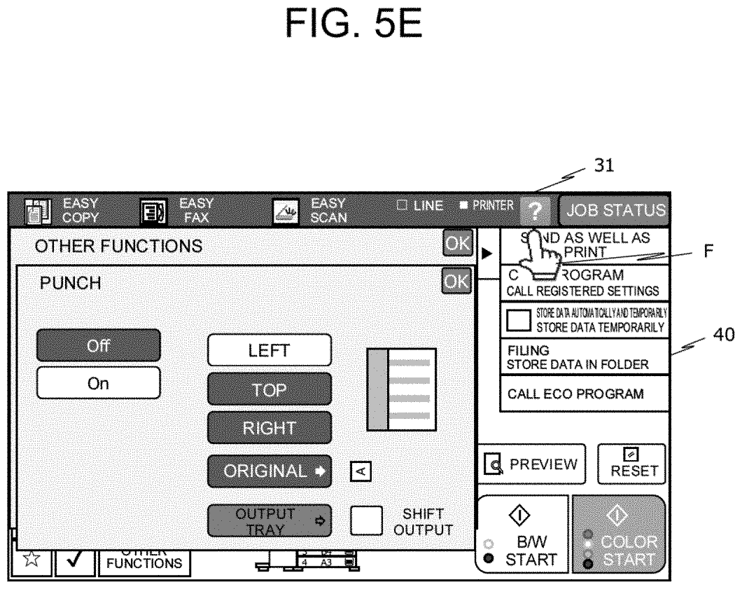

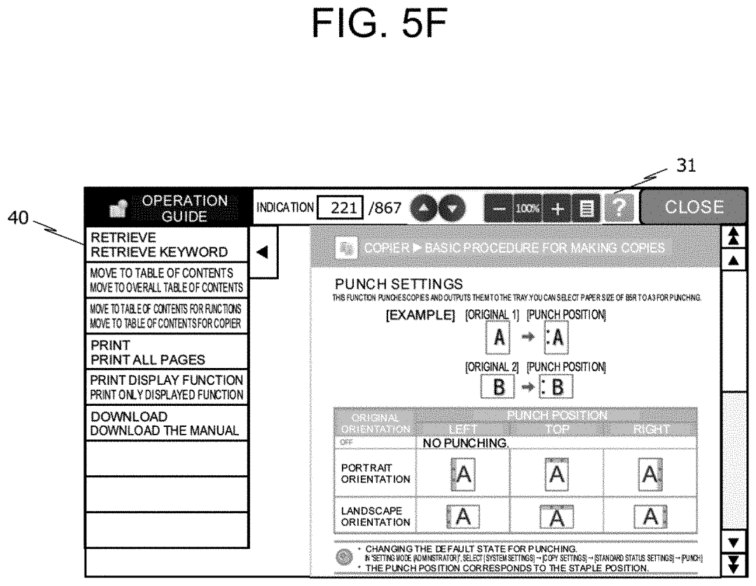

FIG. 4A illustrates the operation performed by the user to select Easy Copy on the same home screen as that in FIG. 3A. It can be said that a copy operation screen is one of the screens located below the home screen in the operation screen tree. FIG. 4B illustrates that the job controller 11J displays the copy operation screen in an easy mode in response to the above operation and the user performs the operation to touch the operation guide key 31 with the finger F on the screen. The copy operation screen is an example of a job that is selectable on the home screen. According to the present embodiment, it is assumed that the user is able to select the operation screen for each job in the easy mode illustrated in FIG. 4B and a normal mode illustrated in FIG. 5C.

In response to the operation of the operation guide key 31 on the copy operation screen, the job controller 11J displays the table of contents for a copy job as illustrated in FIG. 4C. As is the case with FIG. 3C, when any item in the displayed table of contents is touched, the job controller 11J displays the explanation part corresponding to the touched item as an operation guide. FIG. 4D illustrates a part of the printed operation manual corresponding to the operation guide illustrated in FIG. 4C. FIG. 4D illustrates no hidden parts. In the example illustrated in FIG. 4C, it is assumed that the function regarding any item may be set up with the current configuration.

FIGS. 5A to 5F illustrate an example of the case where the operation guide key 31 is operated on a screen for a function setting located further below the copy operation screen in the operation screen tree.

FIG. 5A illustrates the operation performed by the user to select Easy Copy on the home screen as is the case with FIG. 4A. FIG. 5B illustrates the operation performed by the user to touch a “detail” key 39 on the copy operation screen in the easy mode. In response to the operation, the job controller 11J switches the copy operation screen in the easy mode to a copy operation screen (see FIG. 5C) in the normal mode.

As illustrated in FIG. 5C, the copy operation screen in the normal mode includes operation keys (function keys) for setting functions for jobs at the left end portion thereof, operation keys for inputting the number of copies at the center portion thereof, and a machine silhouette displayed to indicate the configuration and status of the multifunction peripheral 100 at the lower center portion thereof. A group of action keys (an action panel 40) for job-related operations is arranged from the upper portion to the center portion on the right end. The group of action keys may be hidden or displayed again by touching a horizontal arrow key at the upper left portion thereof. A preview key, a setting reset key, and a copy start key are provided at the lower right end portion.

FIG. 5C illustrates the operation performed by the user to touch an “other functions” key 41 with the finger F on the copy operation screen in the normal mode.

In response to the operation, the job controller 11J displays an operation window for the “other functions” on part of the copy operation screen (see FIG. 5D). FIG. 5D illustrates the operation performed by the user to touch a “punch” key 43 with the finger F on the operation window for the “other functions”.

In response to the operation, the job controller 11J displays an operation window for the “punch” function on the operation window for the “other functions” in a superimposed manner (see FIG. 5E). FIG. 5E illustrates a case where the operation guide key 31 is operated while the operation window for the “punch” function is displayed.

In response to the operation, the job controller 11J displays an item for the punch setting as an operation guide (see FIG. 5F). In FIG. 5F, the action panel 40 is displayed at the left end portion.

### Second Embodiment

In the present embodiment, a description is given of the mode where, when an unacceptable operation is performed, the job controller 11J displays the reason why the operation is unacceptable as an operation guide.

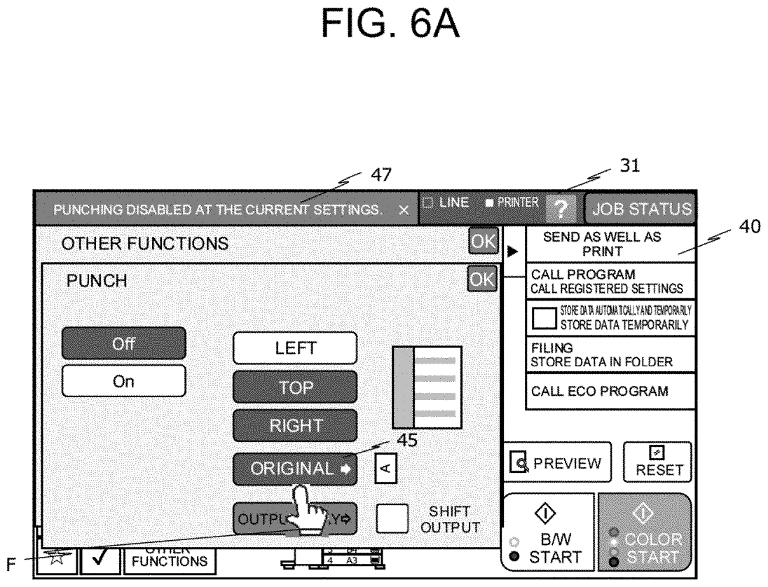

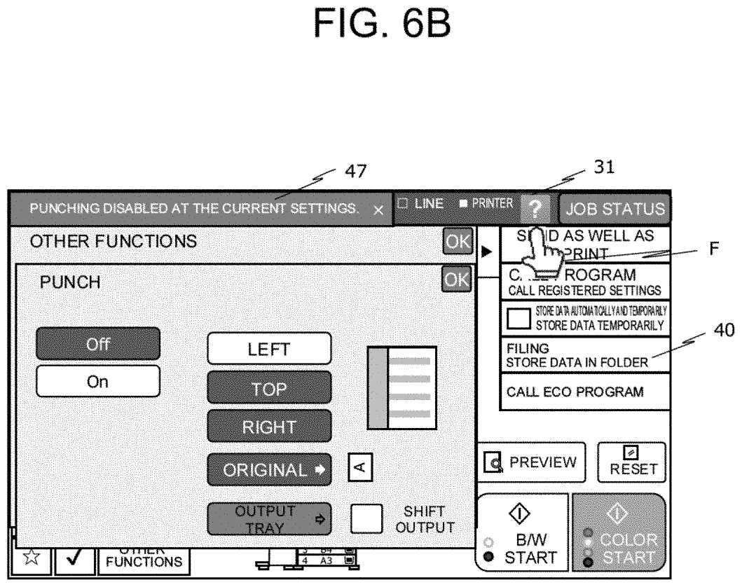

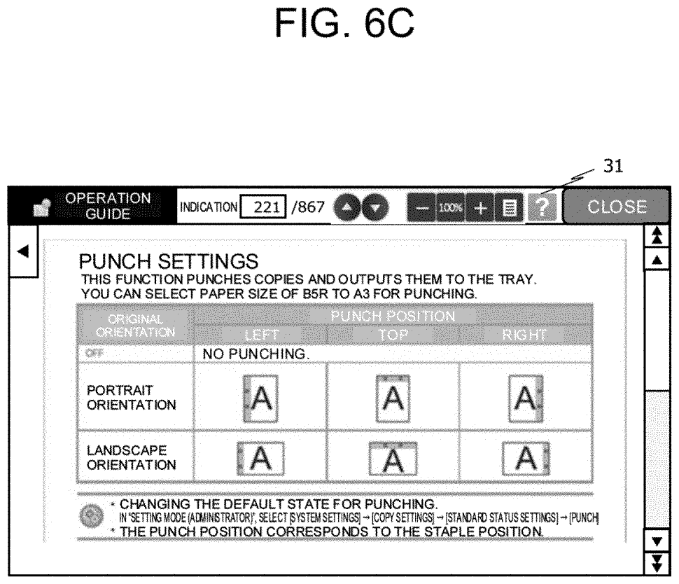

FIGS. 6A to 6C illustrate the case where an operation is performed for an unacceptable setting on the operation window for the “punch” function illustrated in FIG. 5E. Specifically, in FIG. 6A, on the operation window for the “punch” function, the user sets the landscape orientation as the orientation of the original and sets the left side of the original image as the punch position.

In this example, the punch unit built in the saddle finisher (large stacker) has the function to punch the leading edge portion of the fed paper. Both the original size and the paper size are A4. It is assumed that vertically oriented A4 paper, which is fed with its longitudinal direction in a feeding direction, is not placed in any paper trays and only horizontally oriented A4 paper, which is fed with its transversal direction in a feeding direction, is placed. The punch position is determined based on the orientation of the original image, and it is assumed that the user has set the landscape orientation as the orientation of the original image as illustrated on the right side of an “original” key 45. The left side of the original image is set as a punch position. Although the original image may be rotated as appropriate, the punch unit is not able to punch at the position corresponding to the setting in any rotation direction. The job controller 11J displays an unacceptable setting message 47 at the upper portion of the display screen so as to inform the user (see FIG. 6A).

In that status, the user operates the operation guide key 31 (see FIG. 6B), and accordingly the job controller 11J displays the part related to the content of the unacceptable setting message 47 as an operation guide (see FIG. 6C). The job controller 11J manages internal variables for the settings and execution of jobs and, based on the internal variable, displays the unacceptable setting message 47. By controlling the logic for selecting an unacceptable operation message corresponding to the situation in addition to the part of the operation guide to be accordingly displayed, the job controller 11J may determine the part to be displayed as an operation guide.

### Third Embodiment

The functions of the multifunction peripheral 100 may be individually prohibited and permitted using system settings that are not illustrated in FIGS. 3A to 6C. For the system settings, setting icons at the lower portion of the home screen illustrated in FIGS. 3A, 4A, and 5A may be operated so as to enter the settings menu (not illustrated).

As the job controller 11J manages each of the functions prohibited or permitted by the system settings as an internal variable, the status of each function is applied to the operation panel and the operation guide.

A description is given of, for example, a case where the function of “send as well as print” displayed on the action panel 40 on the copy operation screen in the normal mode illustrated in FIG. 5C is prohibited by the system setting. The “send as well as print” function is to send a fax while making a copy of the image of the original read as a copy job.

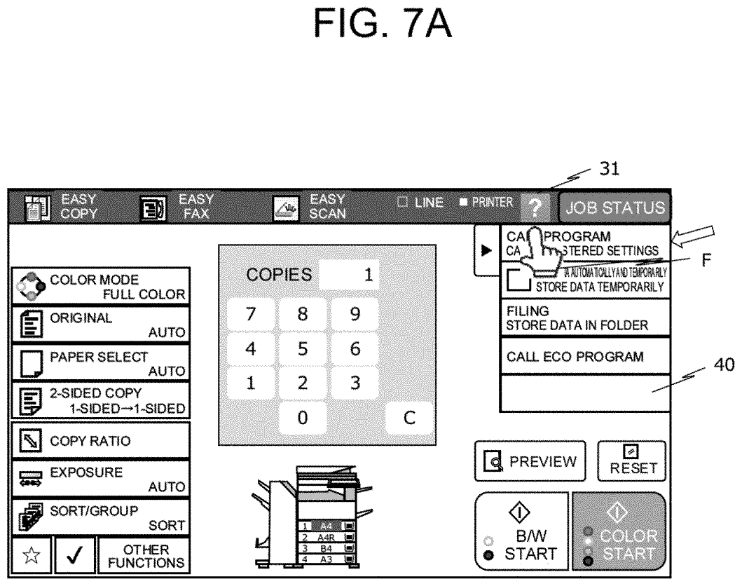

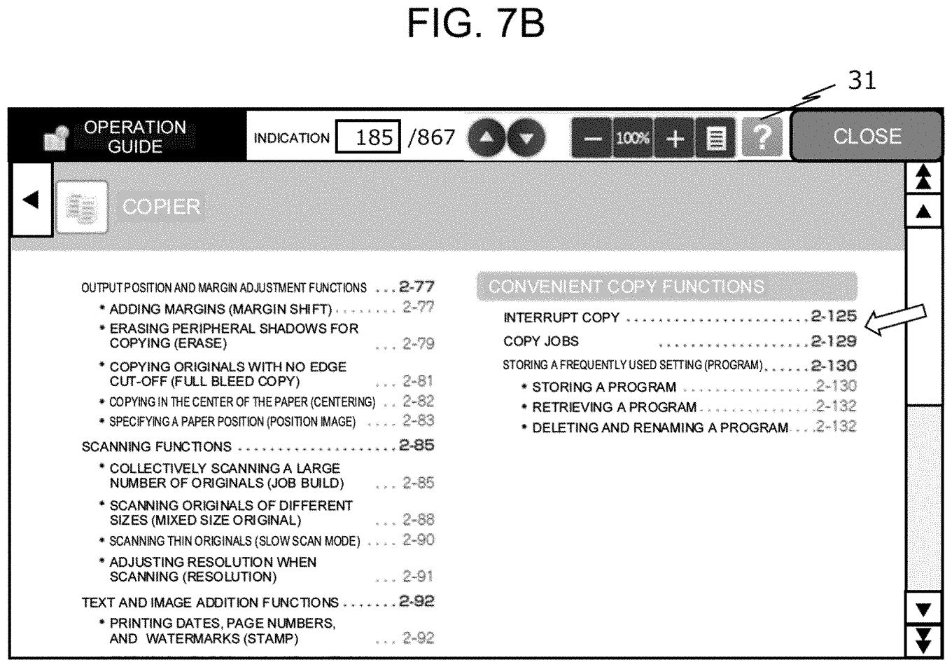

When the “send as well as print” function is prohibited by the system setting, the job controller 11J does not display “send as well as print” on the action panel 40 as illustrated in FIG. 7A. It may be understood from the comparison between the portion indicated by a white arrow on the action panel 40 of FIG. 7A and the corresponding portion of FIG. 5C. This is because the “send as well as print” function is prohibited by the system setting and is not selectable. When the operation guide key 31 is operated on the screen illustrated in FIG. 7A, the job controller 11J accordingly displays the table of contents for a copy job as an operation guide (see FIG. 7B), from which the item “send data while copying” is omitted. It may be understood from the comparison between the portion indicated by a white arrow on the screen of the operation guide in FIG. 7B with the corresponding portion in FIG. 4C.

### Fourth Embodiment

The operation guide may include the illustration of an operation screen and the illustration of a machine silhouette. In the printed operation manual, standard examples are used as the illustrations. The job controller 11J, which manages internal variables, determines the current statuses with regard to the configuration and the status of the multifunction peripheral 100 and the display content of the operation screen and applies the current statuses to the display of the operation screen. Therefore, the current statuses may also be applied to the illustration of the operation guide. In order to achieve this, the process needs to be performed to select and combine display elements for the illustration of the operation guide as well as the display of the operation panel depending on the situation. The job controller 11J, which displays the operation screen, merely applies the same process as that for the operation screen to the illustration portion of the operation guide.

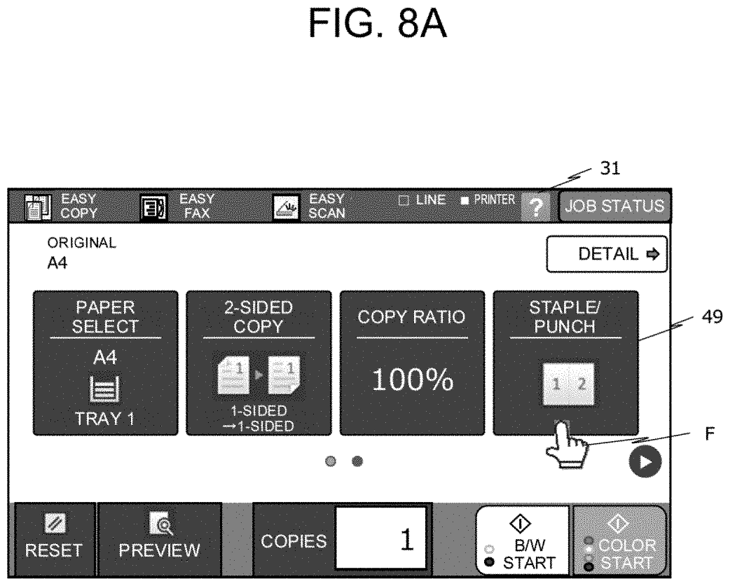

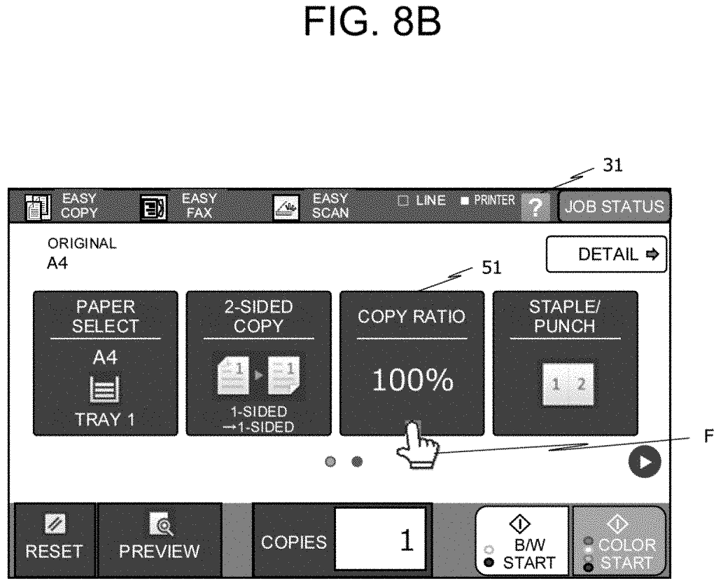

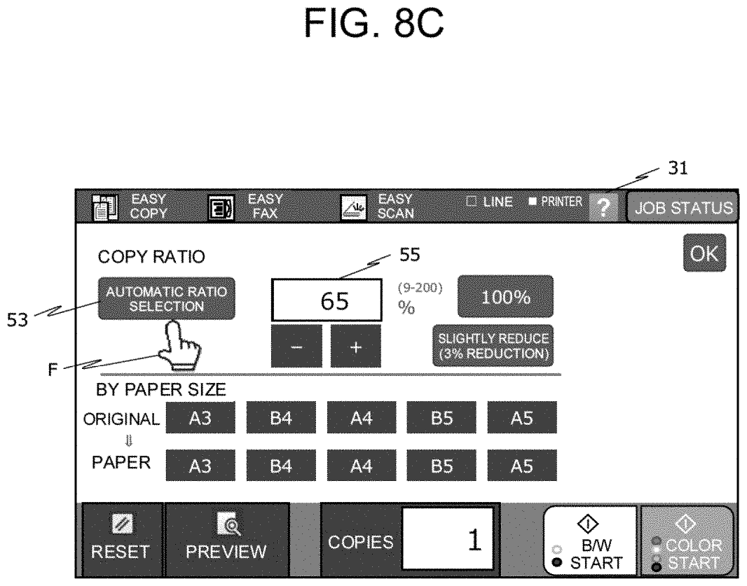

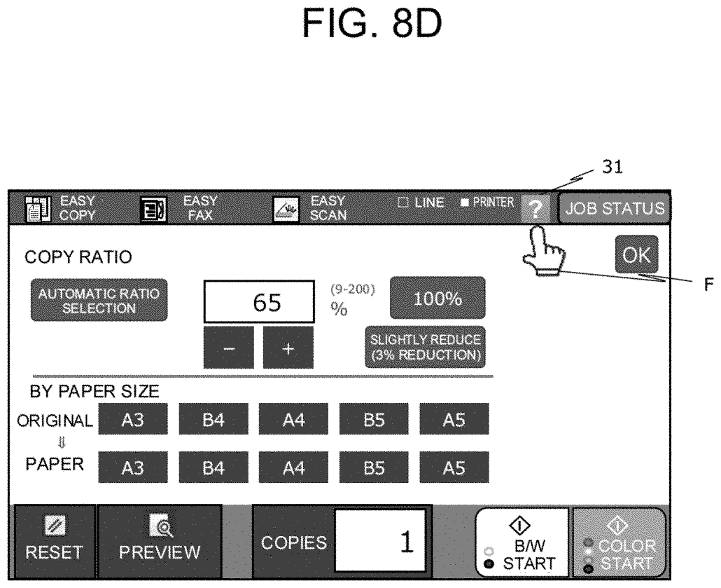

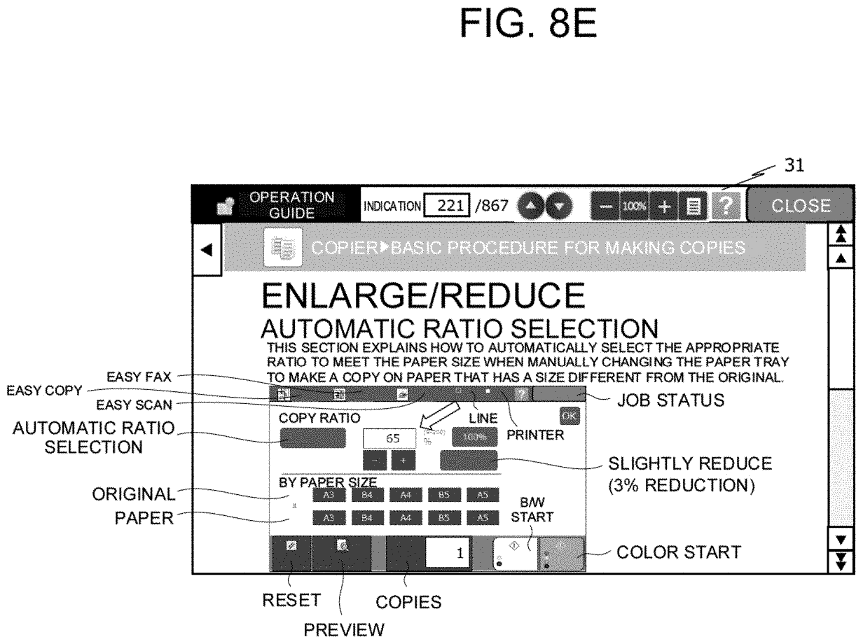

For example, FIGS. 8A to 8E illustrate an example of the combination of the N-Up function and the automatic ratio selection. FIG. 8A illustrates that the user operates an “N-Up” key 49 on the copy operation screen in the easy mode and selects the function so as to make the 2 in 1 setting. FIG. 8B illustrates that the user operates a “copy ratio” key 51 to select the copy ratio setting.

FIG. 8C illustrates a state where the user operates an “automatic ratio selection” key 53 on the copy ratio setting screen displayed by the job controller 11J in response to the operation of FIG. 8B, the job controller 11J sets the copy ratio to 65% based on the operation, and a copy ratio display portion 55 displays the copy ratio.

FIG. 8D illustrates that the user further performs the operation to display the operation guide on the operation screen. In response to the operation, the job controller 11J displays the operation guide for the copy ratio setting screen (see FIG. 8E), which includes the illustration of the copy ratio setting screen.

As illustrated in the illustration of the operation guide in FIG. 8E, the job controller 11J displays the illustration of the copy ratio setting screen corresponding to FIG. 8D as an operation guide. As indicated by a white arrow in FIG. 8E, the copy ratio displayed on the copy ratio display portion 55 is also displayed in the illustration of the operation guide.

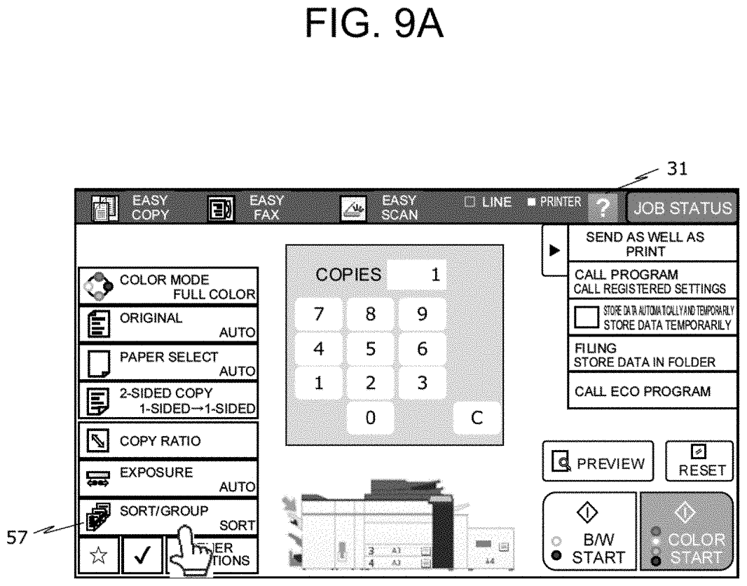

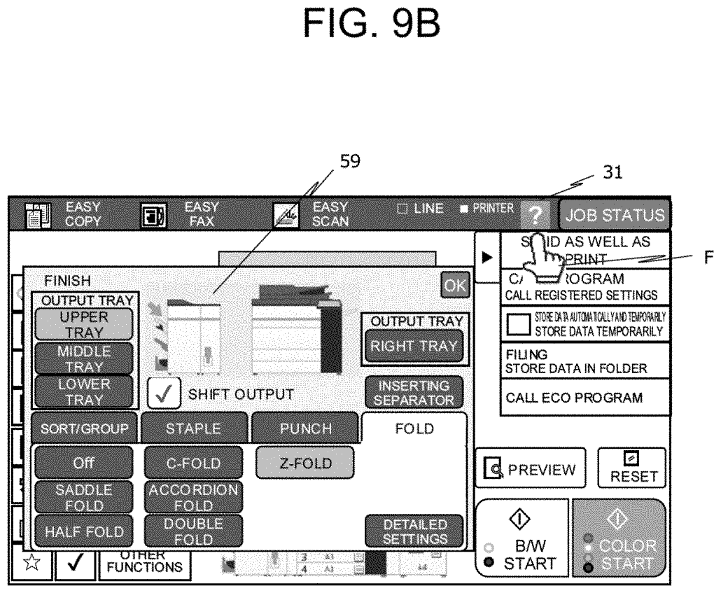

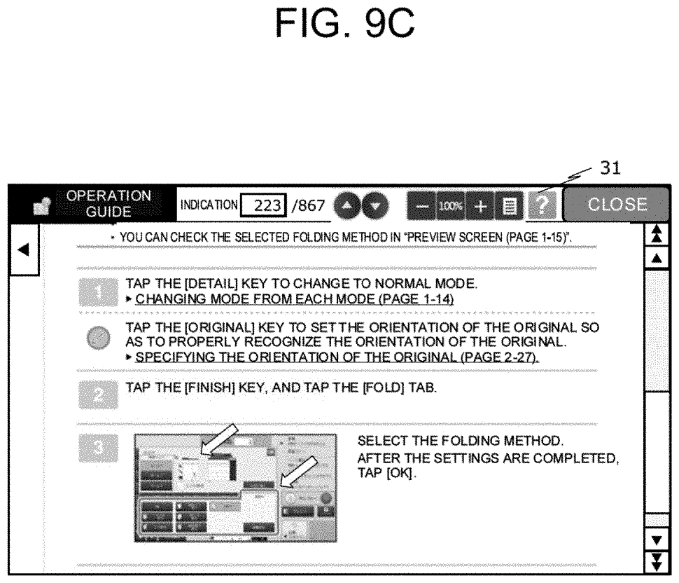

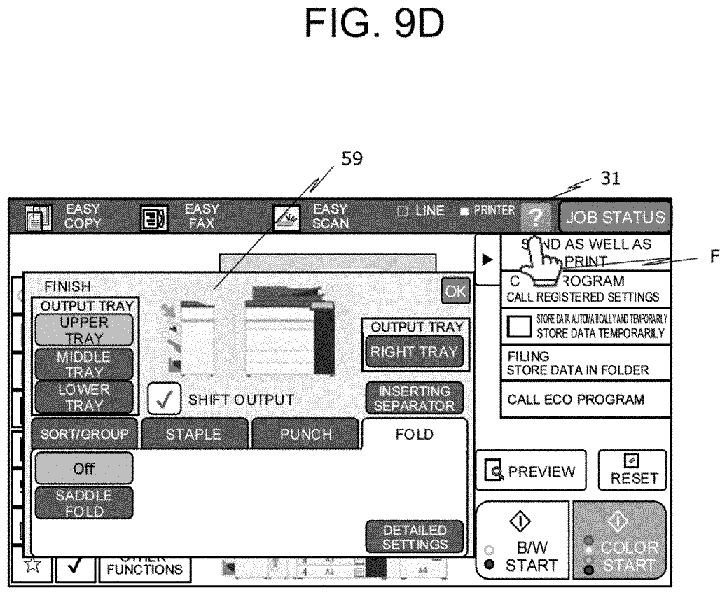

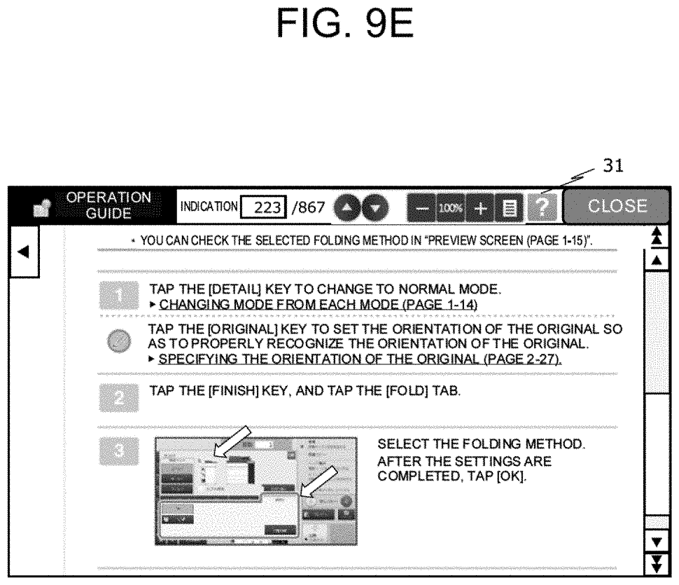

FIGS. 9A to 9E illustrate an example where the machine silhouette displayed on the operation screen is applied to the illustration in the operation guide. Here, an operation screen of a high-speed machine to which many peripheral devices are connectable and attachable is used as an example.

FIGS. 9A to 9C illustrate an example of the configuration in which a paper folding unit and a saddle finisher are connected as peripheral devices for finishing. FIG. 9A illustrates the operation performed by the user to select a “finish” key 57 that is one of the function keys on the copy operation screen in the normal mode.

In response to the operation, the job controller 11J displays an operation window for finishing on part of the operation screen (see FIG. 9B). Functions for finishing are classified as tabs for settings such as sort/group, staple, punch, and paper fold. Each of the tabs is located in the lower half of the operation window. In FIG. 9B, the “fold” tab has been selected among them. The operation keys for selecting the type of paper folding include “off”, “saddle fold”, “half fold”, “C-fold”, “accordion fold”, “double fold”, and “Z-fold”, and in the illustrated state, “Z-fold” has been set.

In the center portion of the upper half of the operation window, a machine silhouette 59 is provided, in which a paper folding unit and a saddle finisher are displayed alongside the main body of the multifunction peripheral 100. As it is understood from the comparison with the machine silhouette in FIG. 9A, only the main body of the multifunction peripheral 100 and the peripheral devices for finishing are displayed on the “finish” operation window, and peripheral devices for paper feeding are omitted therefrom. FIG. 9B illustrates the operation performed by the user to display the operation guide.

In response to the operation, the job controller 11J displays the part for paper folding as an operation guide (see FIG. 9C), which includes the illustration of the finishing operation window.

As indicated by white arrows in FIG. 9C, the job controller 11J applies the finishing operation window illustrated in FIG. 9B to the illustration of the operation guide. The state of the machine silhouette 59 and the paper folding tab illustrated in FIG. 9B is applied to the illustration of the operation guide.

FIG. 9D corresponds to FIG. 9B and differs from FIG. 9B in its configuration without the paper folding unit. Only the saddle finisher is displayed as the machine silhouette 59, and the paper folding unit is not displayed. In the “fold” tab, only the operation keys for “saddle fold” executed by the saddle finisher and “off” are displayed, and the operation keys for paper folding executed by the paper folding unit are not displayed. FIG. 9E is a screen of the operation guide corresponding to FIG. 9C. The job controller 11J applies the state of the operation window in FIG. 9D to the illustration of the operation guide in FIG. 9E. As indicated by white arrows, the state of the machine silhouette 59 and the paper folding tab is applied to the illustration of the operation guide.

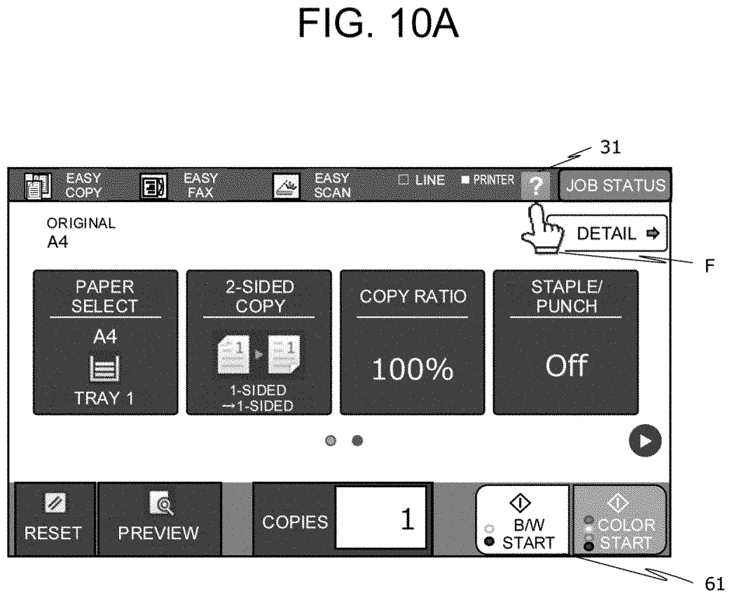

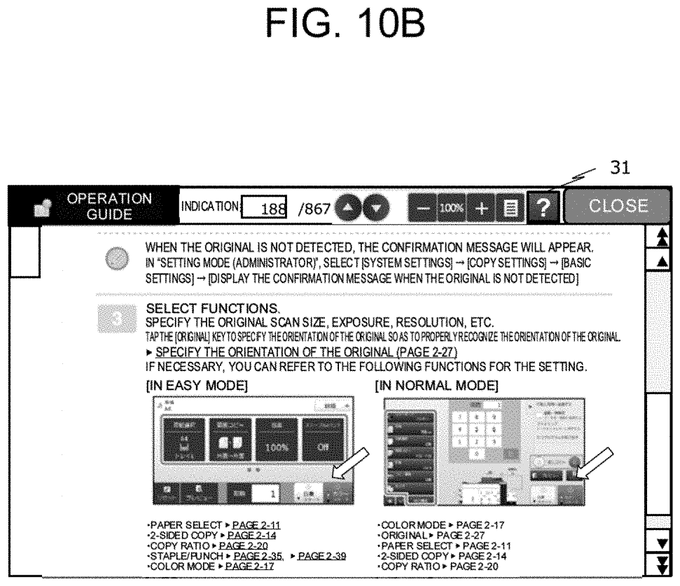

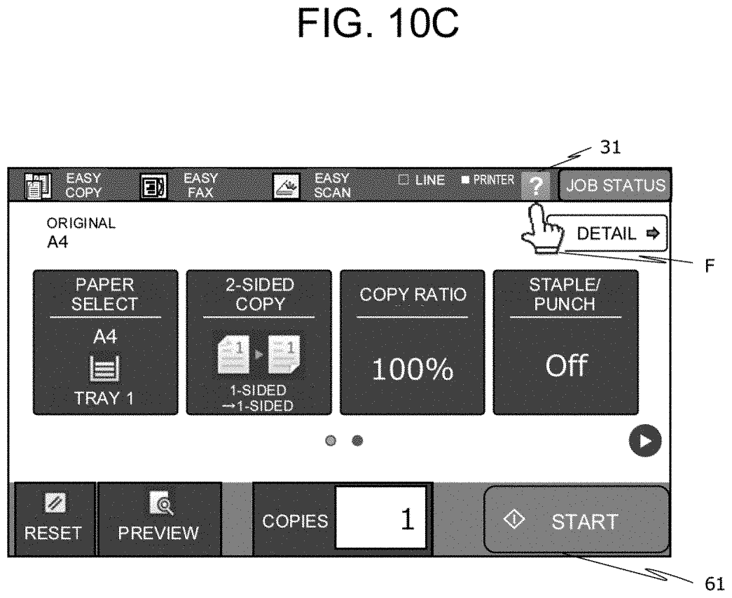

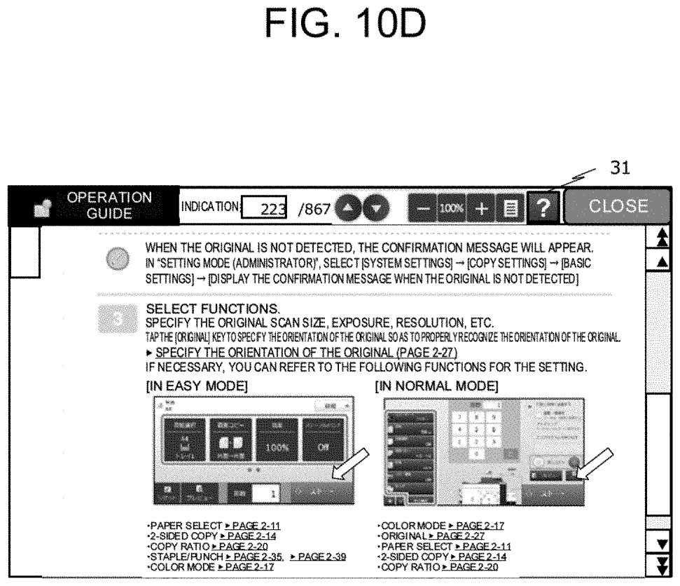

FIGS. 10A to 10D illustrate an example of the case where the system settings are applied to the operation screen and the illustration of the operation guide.

FIG. 10A illustrates the copy operation screen in the easy mode in which both black-and-white copying and color copying are permitted by the system settings. A pair of independent start keys 61 for black-and-white copying and color copying is displayed.

Conversely, FIG. 10C illustrates the copy operation screen in the easy mode in which color copying is prohibited by the system settings and only black-and-white copying is permitted. Only the one start key 61 is displayed, and in response to an operation on the start key 61, the job controller 11J starts a job for black-and-white copying.

FIGS. 10B and 10D illustrate the illustrations of the operation guides corresponding to the copy operation screens in FIGS. 10A and 10C, respectively. As indicated by a white arrow in the illustration of each of the operation guides, the job controller 11J applies the state of the start key 61 to the illustration of the operation guide. Although only the easy mode is illustrated in FIGS. 10A and 10C, the state of the start key 61 is also applied to the copy operation screen in the normal mode and thus also applied to the illustration of the operation guide in the normal mode as well as the easy mode.

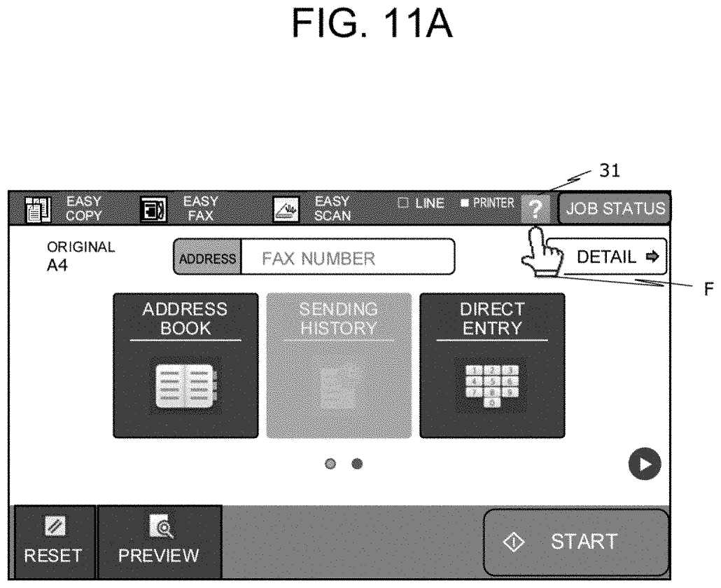

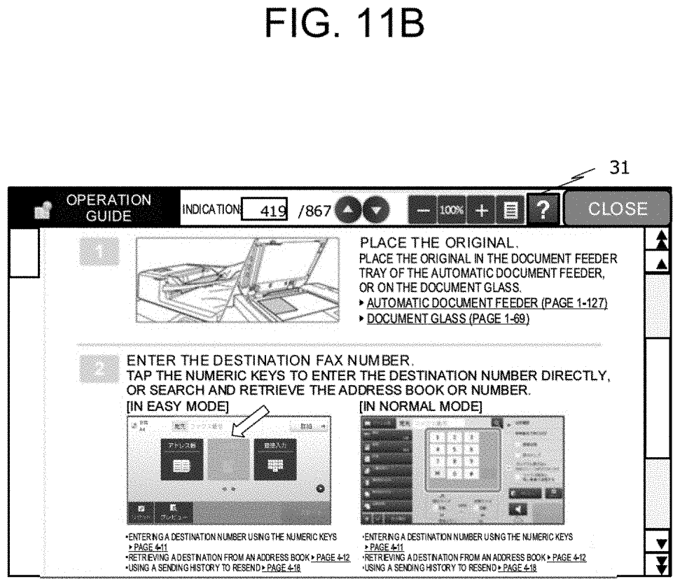

FIGS. 11A and 11B illustrate an example in which the job controller 11J applies the state of the operation screen to the illustration of the operation guide for a fax job that is an example of a job other than a copy job.

FIG. 11A illustrates a fax operation screen in the easy mode in which displaying a sending history is prohibited by the system settings. As illustrated in FIG. 11A, the job controller 11J grays out the operation key for displaying the sending history so as not to receive an operation. When the user requests the display of the operation guide on the screen in FIG. 11A, the job controller 11J accordingly displays the operation guide for the fax operation screen, which includes the illustration of the operation screen.

As illustrated in FIG. 11B, the job controller 11J applies the state of the fax operation screen in FIG. 11A to the illustration of the operation guide. As indicated by a white arrow, the operation key for the sending history is also grayed out in the illustration of the operation guide. Although the same applies to the operation screen in the normal mode, the white arrow is not illustrated because it is hard to understand.

Flowchart for Displaying Operation Guide

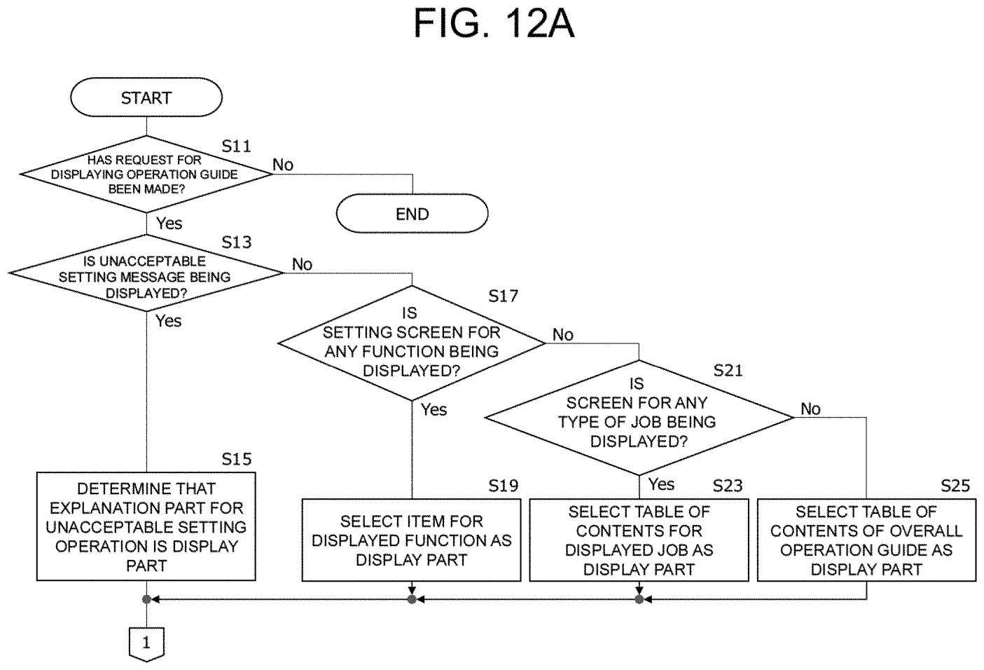

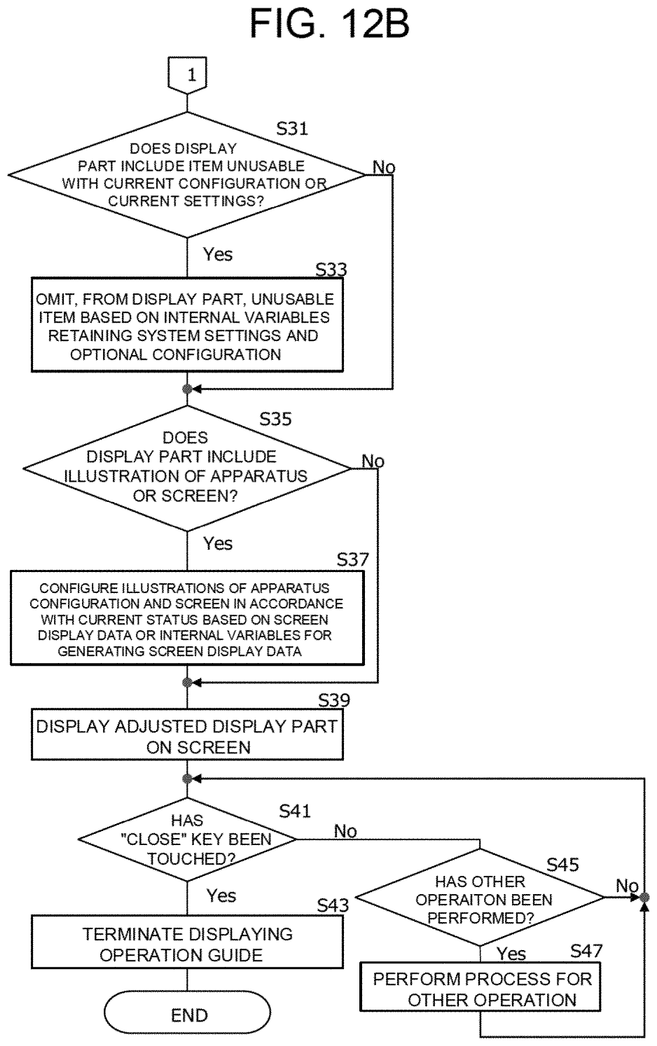

FIGS. 12A and 12B are flowcharts illustrating an example of the process to display an operation guide by the display controller 11D, included in the processes executed by the job controller 11J.

The flow of the process executed by the job controller 11J is described below in accordance with the flowchart.

As illustrated in FIG. 12A, the job controller 11J determines whether the operation recognizer 11R has received an operation on the operation guide key (Step S11). Specifically, it is determined whether a request for displaying the operation guide has been made. When a request for displaying the operation guide has not been made (No at Step S11), the current process is terminated. The job controller 11J repeatedly executes this process.

Conversely, when a request for displaying the operation guide has been made (Yes at Step S11), the job controller 11J determines whether the unacceptable setting message is being displayed (Step S13). When the unacceptable setting message is being displayed (Yes at Step S13), the job controller 11J determines that the explanation part regarding the displayed message is the display part of the operation guide (Step S15), and the process proceeds to Step S31 in FIG. 12B.

Conversely, when the unacceptable setting message is not being displayed (No at Step S13), the job controller 11J then determines whether an operation screen (including an operation window) for any function is being displayed (Step S17). Specifically, it is determined whether it is the operation screen located below the operation screen for any job in the operation screen tree. When the operation screen for any function is being displayed (Yes at Step S17), the job controller 11J determines that an item for the displayed function is the display part (Step S19), and the process proceeds to Step S31 in FIG. 12B.

Conversely, when an operation screen for any function is not being displayed (No at Step S17), the job controller 11J determines whether an operation screen for any type of job is being displayed (Step S21). For example, it is determined whether the operation screen for a copy job is being displayed. When the operation screen for any type of job is being displayed (Yes at Step S21), the job controller 11J determines that the table of contents for that type of job is the display part of the operation guide (Step S23), and the process proceeds to Step S31 in FIG. 12B.

Conversely, when the operation screen for any type of job is not being displayed (No at Step S21), the job controller 11J determines that the home screen at a higher level is being displayed and determines that the table of contents of the overall operation guide is the display part of the operation guide (Step S25), and the process proceeds to Step S31 in FIG. 12B.

As described above, the job controller 11J determines the display part of the operation guide requested.

Subsequently, the job controller 11J determines whether the determined display part includes an item that is unusable with the current configuration of the multifunction peripheral 100 or an item that is unsettable with the current settings (the system settings or settings by operations) (Step S31).

When an unusable or unsettable item is included (Yes at Step S31), the job controller 11J omits the display of the corresponding item. That is, a hidden part is set (Step S33).

When an unusable or unsettable item is not included (No at Step S31), the process at Step S33 is skipped.

Subsequently, the job controller 11J then determines whether the display part includes the illustration of the machine silhouette or the operation screen (Step S35).

When such illustrations are included (Yes at Step S35), the job controller 11J combines components and constructs the content of the illustrations so as to apply the current configuration of the optional device and the current settings and status to the illustrations (Step S37).

When the illustrations are not included (No at Step S35), the process at Step S37 is skipped.

Then, the job controller 11J causes the display controller 11D to display, on the display unit 12, the display content of the operation guide adjusted at Steps S31 to S37 (Step S39).

After the operation guide is displayed, the job controller 11J checks whether a “close” key of the operation guide toolbar 33 has been pressed (Step S41). When it is determined that the “close” key has been pressed (Yes at Step S41), the display of the operation guide is terminated (Step S43) and the process is terminated.

Conversely, when it is determined that the “close” key has not been pressed (No at Step S41), the job controller 11J checks whether an operation has been performed on the other operation keys of the operation guide toolbar 33 (Step S45). When an operation has been performed on the other operation keys (Yes at Step S45), the process regarding that operation is performed (Step S47), and the process is returned to the above-described Step S41 so as to wait for an instruction to end the operation guide.

Similarly, when it is determined that no operation has been performed on the other operation keys at Step S45 described above (No at Step S45), the process is returned to the above-described Step S41 so as to wait for an instruction to end the operation guide.

The above is the process performed by the job controller 11J to display the operation guide.

As described above, (i) the image forming apparatus according to the present invention includes: an operation recognizer that receives, from a user, an operation for a setting and an instruction regarding image formation; a job controller that performs control on the setting and the instruction in response to the operation received by the operation recognizer; an image former that executes image formation in accordance with the setting and the instruction under control of the job controller; and a display controller that displays, to the user, a status regarding the setting and the instruction under control of the job controller, wherein the job controller causes the display controller to display an operation guide for an explanation of the operation in response to a request by the user, and determines an operation guide to be displayed based on at least either a setting when the request is received or a status when the request is received.

According to the present invention, image formation includes not only processing for copying and printing but also processing performed by an image forming apparatus, such as a multifunction peripheral, for example. Their specific modes include, for example, a series of processes (jobs) for copying, printing, scanning, facsimile, etc.

The settings for image formation are related to jobs or individual processes to be performed by the image forming apparatus. Their specific modes are related to, for example, selecting the function to be used and the copy mode to be executed.

According to the present invention, the operation recognizer included in the image forming apparatus receives an operation for the setting, and the display controller included in the image forming apparatus displays a status for the setting. Devices such as a touch panel that receives an operation and a liquid crystal display that makes a display may be located in the image forming apparatus or in an external device connected via a communication. Specifically, according to the above-described embodiment, the operation recognizer receives an operation using a touch panel unit included in the image forming apparatus, and the display controller controls the display of a display unit included in the image forming apparatus. Furthermore, the scope of the present invention also includes the mode for remotely controlling an operation input device or a display device included in an external device with which the operation recognizer and the display controller may communicate via a communication interface.

The specific modes of the operation recognizer, the display controller, and the job controller that controls them include, for example, a CPU or an MPU (hereinafter collectively referred to as “CPU” or “computer”) and a memory as the primary hardware resources. Their functions are performed by the organic combination of the hardware resources and the software resources implemented when the CPU executes a control program stored in the memory.

The image former performs processing such as copying, printing, scanning, or facsimile for jobs. Their specific modes include, for example, a print engine that executes printing and a scanning device that executes scanning for the image of an original. The specific modes also include an image processing circuit that stores and processes image data and print data obtained by scanning an original. According to the above-described embodiment, a scanner unit, a printing unit, and an image processing circuit correspond to the image former.

Further, a preferred mode of the present invention is described.

(ii) The setting may include at least either a setting for permitting or prohibiting a function for image formation or a setting for an addable device, and when a request for the operation guide is received, the job controller may omit an operation guide for at least either a function prohibited by the setting or a device that has not been added.

This makes it possible to omit an operation guide for a function unusable by the user, such as a prohibited function or a device that has not been added, and provide the user with an operation guide exclusively for usable functions.

(iii) The status may include a status regarding a prohibited combination of functions for image formation, and when an operation for the prohibited combination of functions is performed and a request for the operation guide is received, the job controller may prioritize displaying an operation guide for the prohibited combination.

Thus, when the user performs an operation for the prohibited combination of functions and the operation is not accepted, the operation guide for the prohibited combination of functions is displayed so that the user may check and understand the reason why the operation is not accepted.

(iv) The operation guide displayed by the display controller may include an illustration, and the job controller may cause the illustration included in the operation guide to be displayed corresponding to at least any of a current apparatus configuration, a setting, and a status.

Thus, as the illustration to which the current settings and status are applied is displayed as an operation guide, the user-friendly operation guide may be provided.

(v) A preferred mode of the present invention includes a display control method for an operation guide causing a job controller to execute: receiving, by an operation recognizer from a user, an operation for a setting and an instruction regarding image formation; performing control on the setting and the instruction in response to the operation received by the operation recognizer; executing image formation in accordance with the setting and the instruction; displaying, by a display controller, a status regarding the setting and the instruction to a user; and displaying, by the display controller, an operation guide for an explanation of the operation in response to a request by the user, wherein the displaying, by the job controller, determines an operation guide to be displayed based on at least either a setting when the request is received or a status when the request is received.

A preferred mode of the present invention also includes the combination of any of the above-described modes.

Various modifications of the present invention may be implemented besides the above-described embodiments. Such modifications should not be construed as falling outside the scope of the present invention. The present invention is embodied by the claims and their equivalents, and should embrace all of the modifications within the scope of the above.

What is claimed is:

1. An image forming apparatus comprising:
an operation recognizer that receives, from a user, an operation for a setting and an instruction regarding image formation;
a job controller that performs control on the setting and the instruction in response to the operation received by the operation recognizer;
an image former that executes image formation in accordance with the setting and the instruction under control of the job controller; and
a display controller that displays, to the user, a status regarding the setting and the instruction under control of the job controller, wherein
the job controller
causes the display controller to display an operation guide for an explanation of the operation in response to a request by the user, and
determines an operation guide to be displayed based on at least either a setting when the request is received or a status when the request is received.

2. The image forming apparatus according to claim 1, wherein
the setting includes at least either a setting for permitting or prohibiting a function for image formation or a setting for an addable device, and
when a request for the operation guide is received, the job controller omits an operation guide for at least either a function prohibited by the setting or a device that has not been added.

3. The image forming apparatus according to claim 1, wherein
the status includes a status regarding a prohibited combination of functions for image formation, and
when an operation for the prohibited combination of functions is performed and a request for the operation guide is received, the job controller prioritizes displaying an operation guide for the prohibited combination.

4. The image forming apparatus according to claim 1, wherein
the operation guide displayed by the display controller includes an illustration, and
the job controller causes the illustration included in the operation guide to be displayed corresponding to at least any of a current apparatus configuration, a setting, and a status.

5. A display control method for an operation guide causing a computer to execute:
receiving, by an operation recognizer from a user, an operation for a setting and an instruction regarding image formation;
performing control on the setting and the instruction in response to the operation received by the operation recognizer;
executing image formation in accordance with the setting and the instruction;
displaying, by a display controller, a status regarding the setting and the instruction to a user; and
displaying, by the display controller, an operation guide for an explanation of the operation in response to a request by the user, wherein
the displaying, by a job controller, determines an operation guide to be displayed based on at least either a setting when the request is received or a status when the request is received.
